(19) United States
(12) Patent Application Publication
(10) Pub. No.: US 2026/0309865 A1
(43) Pub. Date: Oct. 8, 2026

(54) COMPUTER SYSTEM AND METHOD FOR MARITIME SURVEILLANCE AND SATELLITE-BASED EARTH OBSERVATION OF OBJECTS USING SYNTHETIC APERTURE RADAR IMAGE MATCHING

(71) Applicant: MDA Systems Ltd., Richmond (CA)

(72) Inventors: Adam SCHNEIDER, Vancouver (CA); Hans WEHN, Bowen Island (CA); Farshad NOUBAKSH, Vancouver (CA)

(21) Appl. No.: 19/482,085

(22) PCT Filed: Apr. 26, 2024
(86) PCT No.: PCT/CA2024/050560

§ 371 Date: Nov. 6, 2025

Related U.S. Application Data
(60) Provisional application No. 63/502,555, filed on May 16, 2023.

(51) Int. Cl. G01S 13/90; G06V 10/74; G06V 10/764; G06V 10/82; G06V 10/94; G06V 20/13; G06V 20/52

(52) U.S. Cl. CPC G01S 13/9021; G06V 10/761; G06V 10/764; G06V 10/82; G06V 10/945; G06V 20/13; G06V 20/52

(57) ABSTRACT

Computer systems and methods for identification of unknown vessels are provided. A computer system includes at least one data storage device storing: a database of known synthetic aperture radar (“SAR”) satellite images each containing a known candidate vessel having a known unique vessel identifier; and an unknown SAR satellite image containing an unknown vessel. The system also includes at least one processor configured to execute a SAR-SAR image matcher configured to: compare, via a neural network, the unknown SAR image to a plurality of known SAR image in the database including determining a match likelihood score; output, via the neural network, a ranked list of the known SAR images based on the determined match likelihood scores; and assign a known unique vessel identifier to the unknown SAR image based on the ranked list.

### TECHNICAL FIELD

The following relates generally to maritime surveillance and satellite-based earth observation, and more particularly to systems and methods for maritime surveillance and satellite-based earth observation using computer vision and machine learning.

### INTRODUCTION

Although ground-based and aircraft platforms may be used, satellites provide a great deal of the remote sensing imagery commonly used today. Satellites have several unique characteristics which make them particularly useful for remote sensing of the Earth's surface. Approaches to performing such remote sensing includes using imaging techniques, such as high-resolution optical imaging and synthetic aperture radar (“SAR”) imaging.

One particular domain in which satellite imaging is used is earth observation. Various problems in earth observation may benefit from satellite imaging. One such example is vessel detection (including the ability to detect non-transmitting dark ships, illegal fishing activity, etc.). More generally, it may also be desirable to track an object (e.g., a marine vessel) across multiple images or to confirm that an object present in one image is the same as a known object present in another image.

In some cases, available data may include SAR satellite images. SAR images may include known objects, in the sense that a respective SAR image containing an object may be associated with a unique object identifier that identifies the object. It may be desirable to confirm an identity of an unknown object in a new SAR satellite image using existing SAR satellite imagery containing objects with known identity.

Accordingly, there is a need for an improved system and method for maritime surveillance and satellite-based earth observation that overcomes at least some of the disadvantages of existing systems and methods.

### SUMMARY

A computer system for computer vision-based maritime surveillance and identification of unknown vessels is provided. The system includes at least one data storage device storing: a database of known synthetic aperture radar (“SAR”) satellite images each containing a known candidate vessel, each known candidate vessel having a known unique vessel identifier associated therewith that is stored in the database and which identifies the known candidate vessel; and an unknown SAR satellite image containing an unknown vessel. The system also includes at least one processor configured to execute a SAR-SAR image matcher configured to: compare, via a neural network, the unknown SAR image to a plurality of known SAR image in the database, the comparing including determining a match likelihood score indicating a likelihood that the unknown vessel in the unknown SAR image and a known vessel in a respective known SAR image are a match; output, via the neural network, a ranked list of the known SAR images, the ranked list based on the determined match likelihood scores, wherein a higher ranking in the ranked list indicates a higher match likelihood score and greater likelihood of the known vessel in the known SAR image being the same as the unknown vessel in the unknown SAR image; and assign a known unique vessel identifier to the unknown SAR image based on the ranked list.

The SAR-SAR image matcher may be further configured to store the unknown SAR image as a new known SAR image in the database, the database including the assigned known vessel identifier in association with the new unknown SAR image.

The at least one processor may be further configured to execute a user interface module configured to display a graphical user interface including a graphical representation of the ranked list and receive a user input selecting a known SAR image from the ranked list, and the assigning may include assigning, in response to the user input, the known vessel identifier associated with the selected known SAR image to the unknown SAR image.

The graphical representation of the ranked list may include, for each known SAR image in the ranked list, a visual representation of the known SAR image.

Assigning the known unique vessel identifier to the unknown nadir image may be performed automatically without user input by the SAR-SAR image matcher based on a match likelihood score of a known SAR image associated with the known unique vessel identifier exceeding a predetermined threshold match likelihood score.

The at least one processor may be further configured to execute a user interface module configured to: display a graphical user interface including the assignment of the known vessel identifier to the unknown SAR image and a visual representation the known SAR image associated with the known unique vessel identifier and the unknown SAR image; and receive a user input confirming or rejecting the assignment.

The unique vessel identifier may be a maritime mobile service identify number.

The neural network may be a Siamese neural network configured to receive a plurality of SAR image pairs as input, each SAR image pair including the unknown SAR image and a known SAR image from the database.

A trajectory comprising a time and location of the unknown vessel may be encoded with the unknown SAR image and used by the at least one processor to determine the plurality of known SAR images to which the unknown SAR image is compared by the SAR-SAR image matcher.

The plurality of known SAR images may represent a list of candidate vessels identified by a feasible vessel finder module based on a trajectory of unknown vessel in the unknown SAR image.

The at least one processor may be further configured to execute the feasible vessel finder module to obtain the list of candidate vessels.

The unknown SAR image may have only one time and location encoded therewith that is used to determine the plurality of known SAR images for comparison with the unknown SAR image via a trajectory analysis.

A method of computer vision-based maritime surveillance and identification of unknown vessels is also provided. The method includes: comparing, via a neural network, a cropped unknown synthetic aperture radar (“SAR”) image chip to at least one known SAR image chip of a known vessel stored in a SAR imagery database, the comparing including determining a match likelihood score indicating a match likelihood level between the cropped unknown SAR image chip and the compared known SAR image chip, the known SAR image chip containing a known candidate vessel having a known unique vessel identifier associated therewith that is stored in association with the known SAR image chip and which identifies the known candidate vessel; outputting, via the neural network, a ranked list of the known SAR image chips that were compared to the cropped unknown SAR image chip, the ranked list based on the determined match likelihood scores, wherein a higher ranking in the ranked list indicates a higher match likelihood score and greater likelihood of the known vessel in the known SAR image chip being the same as the unknown vessel in the unknown SAR image chip; and assigning at least one unique vessel identifier to the cropped unknown SAR image chip based on the ranked list.

The method may further include identifying a trajectory of the unknown vessel in the unknown SAR image chip and using the trajectory to identify a subset of the known SAR image chips in the SAR imagery database for comparison to the unknown SAR image.

A computer system for computer vision-based identification of unknown objects in SAR imagery is provided. The system includes at least one data storage device storing: a database of known synthetic aperture radar (“SAR”) satellite images each containing a known candidate object, each known candidate object having a known unique object identifier associated therewith that is stored in the database and which identifies the known candidate object; and an unknown SAR satellite image containing an unknown object. The system also includes at least one processor configured to execute a SAR-SAR image matcher configured to: compare, via a neural network, the unknown SAR image to a plurality of known SAR image in the database, the comparing including determining a match likelihood score indicating a likelihood that the unknown object in the unknown SAR image and a known object in a respective known SAR image are a match; output, via the neural network, a ranked list of the known SAR images, the ranked list based on the determined match likelihood scores, wherein a higher ranking in the ranked list indicates a higher match likelihood score and greater likelihood of the known object in the known SAR image being the same as the unknown object in the unknown SAR image; and assign a known unique object identifier to the unknown SAR image based on the ranked list.

A method of computer vision-based identification of unknown objects in SAR imagery is also provided. The method includes: comparing, via a neural network, a cropped unknown synthetic aperture radar (“SAR”) image to at least one known SAR image of a known object stored in a SAR imagery database, the comparing including determining a match likelihood score indicating a match likelihood level between the cropped unknown SAR image and the compared known SAR image, the known SAR image containing a known candidate object having a known unique object identifier associated therewith that is stored in association with the known SAR image and which identifies the known candidate object; outputting, via the neural network, a ranked list of the known SAR image that were compared to the cropped unknown SAR image, the ranked list based on the determined match likelihood scores, wherein a higher ranking in the ranked list indicates a higher match likelihood score and greater likelihood of the known object in the known SAR image being the same as the unknown object in the unknown SAR image; and assigning at least one unique object identifier to the cropped unknown SAR image based on the ranked list.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a computer system for vessel identification using SAR-SAR image matching, according to an embodiment;

FIG. 2 is a schematic diagram of a Siamese network architecture for use in a SAR-SAR image matcher, according to an embodiment;

FIG. 3 shows examples of SAR-ship images with the same unique identifier (MMSI) and with different unique identifiers, wherein the top row illustrates SAR ships with the same unique identifier and the bottom row illustrates SAR ships with different unique identifiers, according to an embodiment;

FIG. 4 is a block diagram of a Siamese neural network architecture for bi-temporal SAR-Ship comparison, for use in a SAR-SAR image matcher, according to an embodiment;

FIG. 5 is a graph plotting accuracy obtained for a Siamese model with transfer learning, shuffling and data augmentation setting (With-PSA) and No-PSA setting for different number of epochs, according to embodiments;

FIG. 6 is a graph plotting a comparison between balanced and imbalanced data, illustrating that by increasing the negative class the accuracy improves to 78.5%, according to an embodiment;

FIG. 7 is a graph plotting a comparison between a normalized and non-normalized imbalanced dataset, according to an embodiment, showing both models reaching 78.5% accuracy in different epochs;

FIG. 8 is a graph plotting an ROC curve obtained on the evaluation portion of the imbalanced without normalization SAR evaluation dataset for a proposed Siamese model with transfer learning and L2 regularization, according to an embodiment;

FIG. 9 is a histogram of similarity scores for positive and negative image pairs, for SAR-SAR image matching with proposed Siamese model, according to an embodiment;

FIG. 10 is a histogram illustrating three ship size categories including small (0px<L<60px), medium (60px<L<200px), and large (200px<L<450px), according to an embodiment;

FIG. 11 is a graph plotting a Precision vs. Recall curve for a Siamese model for SAR-SAR image matching on a SAR-Ship dataset filtered by ship size using AIS length, according to an embodiment;

FIG. 12 is a flow diagram of a method of object identification in a new SAR satellite image using SAR satellite images containing known objects, according to an embodiment;

FIG. 13 is a block diagram of a computer system for vessel identification including a SAR-SAR image matcher, such as the SAR-SAR image matcher of FIG. 1, according to an embodiment;

FIG. 14 is a schematic diagram of a computer system for object identification using SAR-SAR image matching, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to maritime surveillance and satellite-based earth observation, and more particularly to systems and methods for maritime surveillance and satellite-based earth observation using computer vision and machine learning.

The term “known SAR image” and its variants as used herein refers to a SAR image of or that contains a known object. A “known object” refers to an object (e.g., a vessel) in the image that has been identified and assigned a unique identifier (e.g., a MMSI number), which is stored in association with the “known SAR image”. Accordingly, a “known SAR image” may be considered “a SAR image of a known object”. The term “unknown SAR image” and its variants as used herein refers to a SAR image of or that contains an unknown object. An “unknown object” refers to an object (e.g., a vessel) in the image that has not yet been identified and assigned a unique identifier (e.g., a MMSI number), which is stored in association with the “unknown SAR image”. Accordingly, an “unknown SAR image” may be considered “a SAR image of an unknown object”. For both unknown and known SAR images, the source of the images (i.e., where they came from) and the time and allocation of the area in the respective image are known.

While many of the embodiments described herein are directed to marine vessel identification, it is to be understood that the systems and methods of the present disclosure may be used, in variations, to perform identification of other types of objects though SAR-SAR image matching and the applications of the systems and methods of the present disclosure are not limited to vessel detection. Thus, it is understood that reference in the present disclosure to “vessel” or “vessel detection” is merely one example and is meant to include any type of object suitable for nadir-oblique image matching as described herein.

The present disclosure provides systems and methods for tackling the vessel identification problem based on image sources using state-of-the-art machine learning and computer vision approaches from the sub-field of one-shot/low-shot image recognition.

Vessel identification as used herein and as performed using the systems and methods of the present disclosure may refer to vessel identification in absolute terms with the retrieval of an absolute identity (e.g., MMSI number or other unique vessel identifier) of the vessel of interest (e.g., from a large database of images). This may occur, for example, where a system operator is interested in inspecting a few vessels appearing in a given image, to check for their identity/characteristics from an existing vessel database.

Vessel identification as used herein and as performed using the systems and methods of the present disclosure may refer to vessel identification in relative terms by re-identifying a given vessel among a reduced list of candidates. In this case, the vessel identification may be used to uniquely re-identify the same vessel across multiple images, supporting the task of vessel tracking. This may happen at a short temporal scale, for example, where multiple images are acquired within a few hours along a maritime corridor where ships have to be re-identified and matched across acquisitions. A similar approach may be applied at a larger temporal and spatial window, for instance in the case of the search and tracking of a suspicious vessel that might have visited multiple ports or entered a monitored zone (vessel on a “watch list”), days or even months apart.

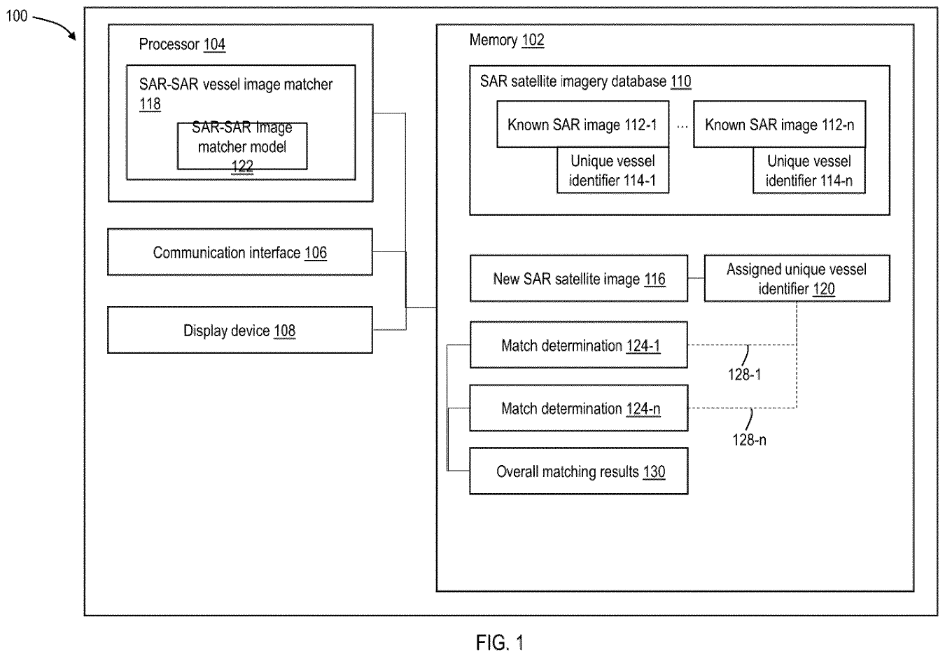

Referring now to FIG. 1, shown therein is a system 100 for vessel identification using SAR-SAR image matching, according to an embodiment. The system 100 may implement SAR-based vessel reidentification via image matching.

In an embodiment, the system 100 uses SAR satellite images to identify dark vessels by matching a new SAR satellite image to a database of SAR imagery of known vessel candidates. Generally, the system 100 can be used to determine if a vessel in a first SAR satellite image (which may be a cropped SAR image or SAR image chip) is the same vessel as one seen in a second SAR satellite image (which may be a cropped SAR image or SAR image chip).

In a particular example, the system 100 may be used in a scenario where multiple high resolution SAR images have been acquired over a region where a suspicious dark vessel trajectory has been identified. Multiple vessels may have been detected in the SAR images and a SAR-SAR image matcher network (e.g., model 122, described below, which may be Siamese network) is configured to determine if two cropped SAR images of vessels taken at different times are in fact the same vessel or not.

The system 100, or a subset of components thereof, may be implemented as part of a larger vessel identification system (e.g., a platform to aid in dark vessel detection). For example, in an embodiment, the system 100 may be implemented along with one or more of a nadir-nadir image matcher and a nadir-oblique image matcher, where the outputs of multiple models each directed to different image source pairs are further processed to perform vessel identification.

The system 100 may include one or more computer devices. For example, the system 100 may include a plurality of computer devices in communication via a network connection. Further, components of the system 100 may be implemented at a single computer device, or across a plurality of computer devices.

In some embodiments, the system 100 includes at least one user computing device and at least one server computing device in communication via a network connection. The user device may execute an application that can interact with server-side software components (“services”) hosted by the server computing device. For example, the computer system 100 may execute a network-based software application that executes partially at the server computing device (via server-side software components) and partially at the user device (via client-side software components). In an embodiment, the client-side software components include a user interface (e.g., web-based user interface).

The system 100 includes a memory 102 and a processor 104 in communication with the memory 102.

The system 100 includes a communication interface 106 for transmitting and receiving data. The communication interface 106 may include a network interface.

The system 100 includes a display 108 for displaying data generated by the system 100. The display 108 may be located at a user device of the system 100.

The memory 102 stores a database 110 of known SAR satellite images (also referred to as “SAR imagery database”). Each known SAR image in the database 110 contains a vessel. The known SAR image may have been acquired by an earth observation satellite.

The database 110 also stores a unique vessel identifier for each known SAR image. The unique vessel identifier identifies the vessel represented in the known SAR image. In an embodiment, the unique vessel identifier is a maritime mobile service identify (“MMSI”) number. The unique vessel identifier is stored in the database 110 such that the unique vessel identifier is associated with (and thus retrievable based on) the known SAR image with which it is associated.

For illustrative purposes, database 110 in FIG. 1 is shown to include known SAR satellite image 112-1 and known SAR satellite image 112-n. In variations, any suitable number of SAR images may be stored in the database 110 and used. The database 110 also stores unique vessel identifier 114-1 and unique vessel identifier 114-n, which are associated with known SAR images 112-1 and 114-n, respectively. Known SAR images 112-1 and 112-n may be referred to collectively as SAR images 112 and generically as SAR image 112.

Given that each known SAR image in the database 110 has an associated unique vessel identifier identifying the vessel in the SAR image, such vessel is considered “known” (i.e., a “known vessel” or “known vessel candidate”, as its identity is known).

The memory 102 also stores a new SAR image 116. The new SAR image 116 contains an unknown vessel (also referred to as a “vessel of interest”). That is, the new SAR image 116 contains a vessel whose identity is unknown and for which a user wants to determine or confirm an identity. Memory 102 may store a plurality of new SAR images 116 that are to be processed by the system 100. In some cases, the new SAR image 116 may be a plurality of images of the same vessel.

The new SAR image 116 may contain a suspicious dark vessel (“vessel of interest” or “unknown vessel”) whose trajectory has been identified. The trajectory may be represented by the time and location of a detection. The time and location of a new SAR image are used to select which known vessel images to put in a candidate list. The candidate list includes a set of known SAR images that are compared (matched) to the unknown SAR image by the SAR-SAR image matcher. The candidate list may be selected or determined by a feasible ship finder module or component. The time and location of the new SAR image may be encoded with the image. The time and location may be encoded by the satellite that captured the image. A trajectory of two or more detections can be formed by associating multiple detections with each other due to the proximity of their locations at the times of detection, combined with other characteristics of the detections such as object size or velocity. The feasible ship finder component identifies whether two detections could possibly belong to the same trajectory or not and removes candidate vessels (e.g., in a database of known SAR images) from the candidate list that could not possibly be the same object due to their last known location. In some embodiments, the trajectory of an unknown SAR image is only required to have one time/location. The enables the feasible ship finder to provide a sufficiently short candidate list, which may avoid a scenario where every existing ship is a candidate. Trajectory may correspond to or be obtained from trajectory data. The trajectory data may be automatic ship identification system (“AIS”). The automatic identification system (AIS) is an automatic tracking system that uses transceivers on ships and is used by vessel traffic services.

In some cases, the new SAR image 116 is a cropped new SAR image (which may also be referred to as a SAR “image chip”). For example, a SAR satellite image may be processed to detect a vessel of interest in the image. This may be performed, for example, by providing the SAR satellite image as input to an object detection model trained to detect one or more classes of vessels of interest in the input image. Detecting may include localizing the vessel in the image (e.g., via a bounding box) and assigning a class label to the vessel. In some cases, a confidence level associated with the class label assignment may also be determined and provided. In some embodiments, the system 100 may include an object detection model for performing vessel detection in SAR satellite images. An annotated version of the SAR satellite image (e.g., annotated with object location/bounding box data) may then be provided as input to a cropping module configured to crop the detected vessel out of the SAR satellite image. In some embodiments, the cropping module may be a component of system 100, for example executed by processor 104. The cropping module generates a cropped new SAR image that includes the detected vessel of interest. In cases where multiple vessels have been detected in an image, a corresponding number of cropped SAR images may be generated (i.e., one cropped image per detected vessel).

In some cases, a general SAR image may vary in its size and spatial area covered. To work with the SAR image, the SAR image may be broken up into “chips” (also referred to herein as “image chips”) that are smaller in size and area than the SAR image from which the chip is generated. Image chips generated from the SAR image may be of a fixed size. For example, image chips generated from a SAR image may be of a fixed size of 512×512 or 1024×1024 pixel chips. In some embodiments, SAR images of ships (or other objects, as the case may be) processed by the system 100 may be chipped so that the ship is in the center of the chip, with one chip per ship. In an embodiment, the chipping of the dataset of SAR images is performed by the system 100. In another embodiment, the SAR images may be provided to the system 100 as image chips (i.e., already having been chipped).

The processor 104 includes a SAR-SAR vessel image matcher 118. The SAR-SAR vessel image matcher 118 may also be referred to “image matcher 118”. The SAR-SAR image matcher 118 compares SAR images of potentially the same object.

The SAR-SAR vessel image matcher 118 determines if the vessel in the new SAR vessel image 116 is the same vessel as a vessel contained in a known SAR vessel image 112.

The SAR-SAR image matcher 118 is configured to determine a specific identity of the unknown vessel in the new SAR image 116 based on known identities of vessels in the database 110 (i.e., in the known SAR images 112). The determined specific identity of the unknown vessel in the new SAR image 116 is represented in the system 100 as an assigned unique vessel identifier 120. The format of the assigned unique vessel identifier 120 is the same as the unique vessel identifiers 114 associated with the known SAR images 112. In an embodiment, the assigned unique vessel identifier 120 is an MMSI number. Generally, the SAR-SAR image matcher 118 may determine and assign the unique vessel identifier 120 to the new SAR image 116 based on a comparison of the new SAR image 116 to one or more known SAR images 112 in the database 110. In FIG. 1, new SAR satellite image 116 has been assigned unique identifier 120, wherein the unique identifier 120 identifies the vessel contained in the SAR image 116. The assigned unique identifier 120 is stored in the database 110 such that the assigned unique identifier 120 is associated with the new SAR satellite image 116 (and thus, with the vessel contained in the image 116) and can be retrieved using the new SAR satellite image 116.

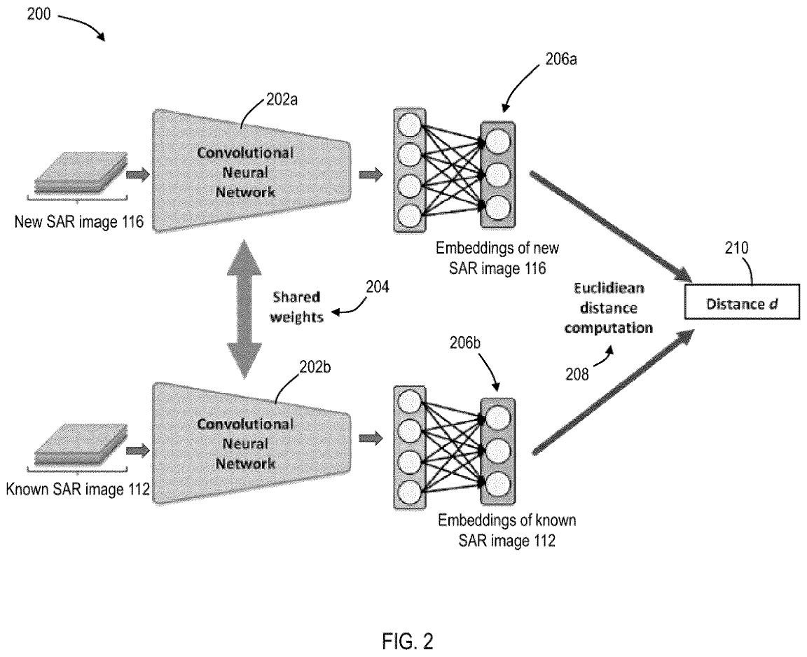

The SAR-SAR image matcher 118 includes a SAR-SAR image matcher model 122 (also referred to as a “neural network” or “neural network model”). The SAR-SAR image matcher model 122 includes an encoder (in some cases, such as shown in FIG. 2, one encoder with two identical copies) for generating compressed feature vectors representing salient and useful features for matching with those in other SAR images. In some embodiments, multiple encoders trained in the same way may be used and their respective output encodings averaged as a form of ensembling.

By using such an approach instead of storing high resolution images in a database, the image matcher 118 may improve storage and efficiency. For example, high resolution images may be stored somewhere, but such images use a lot of space and searching through those images can be a slow process. In the system 100, the high resolution images are only used to train the encoders. Once training of the encoders is finished, the encoders convert the images into compressed feature vectors. The compressed feature vectors use far less space for storage and can be retrieved for comparison and searching much faster. The encoders are optimized (via training) to retain only the necessary information in the feature vectors to decide if their corresponding high resolution images match.

The image matcher model 122 includes a neural network. The neural network may include a Siamese network. The model 122 is configured to receive a plurality of SAR image pairs as input, where each SAR image pair includes the new SAR satellite image 116 and a known SAR image 112 from the database 110. The image matcher model 122 compares the SAR images 116, 112 in the image pair to determine similarity. From the similarity determination, the image matcher model 122 determines whether the vessel in the new SAR image 116 is the same vessel in the known SAR image 112. If the vessel is determined to be the same, the image matcher model 122 (or image matcher 118) may assign or otherwise associate the unique vessel identifier 114 of the known SAR image 112 with the new SAR image 116. For example, if the image matcher model 122 determines that the new SAR image 116 is sufficiently similar to known SAR image 112-1 (e.g., by determining that a similarity level between the images meets a predefined threshold), the image matcher 118 may assign unique vessel identifier 114-1 to the new SAR image 116 as assigned unique vessel identifier 120. In such case, the new SAR image 116 and assigned unique vessel identifier 120 may subsequently be stored in the database 110 as a known SAR image (i.e., for subsequent comparison with other new SAR images).

The image matcher 118 feeds known SAR image 112-1 and new SAR image 116 into the SAR-SAR image model 122. The SAR-SAR image model 122 compares the images 112-1, 116 and outputs a match determination 124-1 based on the comparison. The match determination 124-1 indicates a similarity level between the images 112-1, 116 (to indicate a similarity level between the vessels represented in the images). The match determination 124-1 is stored in memory 102. If it is determined that the match determination 124-1 meets a predefined threshold for a “match” (or if it is “positive”), the image matcher 118 assigns the unique vessel identifier 114-1 to the new SAR satellite image 116 as assigned unique identifier 120. The potential assignment is represented in FIG. 1 by hashed line 128-1.

The image matcher 118 feeds known SAR image 112-n and new SAR image 116 into the SAR-SAR image model 122. The SAR-SAR image model 122 compares the images 112-n, 116 and outputs a match determination 126-n based on the comparison. The match determination 124-1 indicates a similarity level between the images 112-n, 116 (to indicate a similarity level between the vessels represented in the images). The match determination 124-n is stored in memory 102. If it is determined that the match determination 124-1 meets a predefined threshold for a “match” (or if it is “positive”), the image matcher 118 assigns the unique vessel identifier 114-1 to the new SAR satellite image 116 as assigned unique identifier 120. The assignment is represented in FIG. 1 by hashed line 128-1. The potential assignment is represented in FIG. 1 by hashed line 128-n.

In some cases, the image matcher 118 may be configured such that the assigned unique vessel identifier 120 is only assigned to the new SAR image 116 (and stored in the system 100 as such) upon confirmation by a user. For example, the image matcher 118 may determine that a match is present but present the match as a proposed match to the user via a user interface. The user may review and then confirm the proposed match (via user input to the user interface), at which point the image matcher 118 may formally (e.g., permanently) associate the assigned vessel identifier 120 with the new SAR image 116.

In some cases, the match determinations 124-1, 124-n, or some subset thereof (e.g., meeting a predefined similarity threshold), may be stored in the memory 102 as overall matching results 130. The image matcher 118 is configured to generate a graphical user interface including a human-readable representation of the overall matching results 130. The image matcher 118 displays the graphical user interface via the display device 108.

The overall matching results 130 may include, for example, an ordered list of match determinations 124 (or some subset thereof). In some cases, the overall matching results 130 may include the known SAR images associated with their respective match determinations 124. The user interface may be configured to receive a user input accepting or rejecting the match determinations 124. The user interface may provide a user the opportunity to review results and, in some cases, accept, reject, or override results via user input.

The SAR-SAR image matcher 118 may be configured to store the unknown SAR image 116 as a new known SAR image in the database 110, where the database 110 includes the newly assigned known vessel identifier in association with the new unknown SAR image 116 (now a known SAR image).

In some embodiments, the system 100 may configured to execute a user interface module configured to display a graphical user interface including a graphical representation of the overall matching results 130 and receive a user input selecting a known SAR image from the overall matching results 130 (e.g., presented as a list or in other format). The assigning of the identifier 120 may include assigning, in response to the user input, the known vessel identifier associated with the selected known SAR image to the unknown SAR image 110. The graphical representation of the overall matching results 130 may include, for each known SAR image in the ranked list (or other representation of the overall matching results 130), a visual representation of the known SAR image.

In some embodiments, assigning the known unique vessel identifier to the unknown SAR image 110 may be performed automatically without user input by the SAR-SAR image matcher 118 based on the match score of a known SAR image associated with the known unique vessel identifier exceeding a predetermined threshold match score. In some embodiments, the system 100 may be configured to execute a user interface module configured to display a graphical user interface including the automatic assignment of the known vessel identifier to the unknown SAR image 116 and a visual representation the known SAR image associated with the known unique vessel identifier and the unknown SAR image and receive a user input confirming or rejecting the assignment.

Referring now to FIG. 2, shown therein is a Siamese network 200 that may be implemented by the SAR-SAR image matcher 118 for determining whether two SAR images match, according to an embodiment. The Siamese network 200 may be implemented as a component of the SAR-SAR image matcher model 122 of FIG. 1.

Generally, the Siamese network 200 is an artificial neural network that uses the same weights while working in tandem on two different input vectors to compute comparable output vectors. In some cases, one of the output vectors may be precomputed (e.g., an output vector generated from known SAR image 112), which forms a baseline against which the other output vector (e.g., an output vector generated from new SAR image 116) is compared.

The Siamese network 200 includes convolutional neural networks (CNNs) 202a, 202b. The CNNs 202a, 202b have shared weights 204. The CNNs 202a, 202b may be the same CNN, or separate instances of a CNN having shared weights. It should be noted that, in variations, new SAR image 116 and known SAR image 112 may be processed by the network 200 at the same time (or roughly the same time) or at different times (e.g., if known SAR image 112 is processed ahead of time and the output compared to an output generated from the new SAR image 116 when processed).

The CNN 202a generates embeddings 206a of the new SAR image 116.

The CNN 202b generates embeddings 206b of the known SAR image 112. The embeddings 206a, 206b may be stored in memory 102.

The network 200 compares the embeddings 206a, 206b by executing a Euclidian distance computation 208 using the embeddings 206a, 206b as input to obtain a Euclidian distance output ‘d’ 210. The distance d 210 may be stored in memory 102. The distance d is used in the same way as the similarity score, but with distance d and similarity score having an inverse relationship. The larger the distance between two embeddings, the less likely they match, and the smaller the distance, the more likely they match.

Referring again to FIG. 1, the SAR-SAR image matcher 118 may be implemented as part of a larger vessel identification system. The vessel identification system may also include, for example, a nadir-nadir image matcher and a nadir-oblique image matcher. In such embodiments, the SAR-SAR image matcher 118 may perform its task as an identification subtask of the overall vessel identification task. A vessel identification system may include a plurality of individual models directed to comparing two image sources at a time. For example, a first model may be directed to comparing two overhead or nadir satellite image sources, a second model may be directed to comparing an overhead satellite image source and an oblique image source, and a third model may be directed to comparing two SAR image sources (e.g., model 122, as in the SAR-SAR image matcher of the present disclosure). Each of the plurality of models may be a deep neural network. Each of the plurality of models may comprise a Siamese network (such as illustrated in FIG. 2).

Example methods of SAR data preparation for developing a SAR-SAR image matcher (such as image matcher 118), and in particular a SAR-SAR image matcher model 122, will now be described.

Initially, object re-identification using SAR imagery in the native radar geometry was investigated. Variants of ships in different port sites that have a consistent radar shadow orientation were created and are resampled to have an approximately square pixel size. In a particular case, Extra Fine (XF) SGF data (2×2-look of SGF proceed is 6.25 m pixel spacing that is approximation of 8 m resolution) and SGX (1 look of SGX proceed is 2.0 m pixel spacing that is approximation of 5 m resolution) data that are collected from 23 regions in 119 frames that are 18796 chips in total was used. Since RADARSAT-2 images are always oriented approximately North-up for both ascending and descending pass imagery, this normalization step was undone, and descending chips were flipped along an axis of vertical symmetry. To have comparable object shapes and sizes to other geocoded datasets, the radar geometry chips were resampled both in azimuth and range direction using cubic resampling. To prepare this data for the deep learning task, severely defocused and multiple ships in chips (images) are eliminated. While the chip size is selected to be large enough for the largest ships and there is one ship in each chip, this means there can be many smaller ones. After elimination, 15777 chips were selected out of 18796 chips. Of the 15777 image chips, 9315 out of 15777 are labeled as tanker, cargo, fishing and other vessel class types, and then the image chips are normalized by mean and standard deviation of all ship pixels. This dataset may be referred to as a SAR-Ship comparison dataset.

The SAR-Ship comparison dataset may then be used to perform a bi-temporal re-identification task over time by training a CNN model. In this context, the objects being reidentified are ships. In other embodiments, objects other than ships may be identified/matched via the SAR-SAR image matcher.

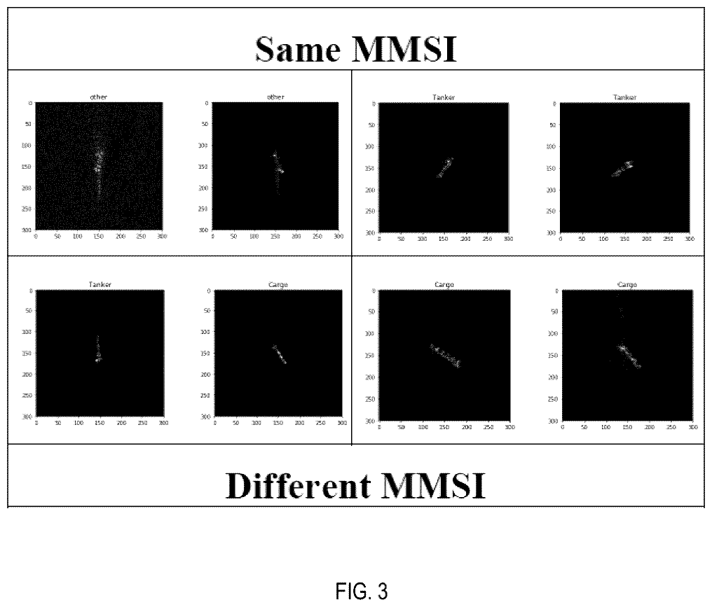

A bi-temporal SAR-Ship task includes training a CNN model to compare two given SAR-Ship images (first and second SAR ship images) taken at two different times and geo-regions and determine whether the first and second SAR ship images are of the same ship or not with respect to a unique vessel identifier (in this case, MMSI number), regardless of possible orientation, scale, and translation changes. FIG. 3 shows examples of SAR-Ships with same MMSI and different MMSIs situations.

In an embodiment, the SAR-Ship comparison dataset contains image-pair examples with ship chips. Each SAR-Ship chip may correspond to an SAR image with a resolution of 300×300 pixels (600 m×600 m).

As a main scenario, the SAR-Ship comparison dataset may be selected to be balanced. The SAR-ship dataset contains 50% positive examples labeled with a one. That is, image pairs with similar ships. The SAR-Ship dataset also contains 50% negative examples labeled with a zero. That is, image pairs with dissimilar ships.

It is noted that the size of the SAR-Ship comparison dataset in this example is rather small as compared with the typical dataset size used for training a deep CNN model. However, as we described below, by combining our representative dataset with some pattern recognition techniques and a transfer learning approach, bi-temporal SAR-Ship re-identification tasks can be performed with an acceptable level of accuracy. In some cases, a specific satellite or SAR dataset as a specific transfer learning approach may be used, to test their effect to boost the performance.

In an embodiment, the SAR-SAR image matcher 118, including the SAR-SAR image matcher network 122, models a bi-temporal SAR-Ship re-identification task as a binary image classification problem. The binary classification problem includes the categories: SAR-Ship with same MMSI number (unique vessel identifier), and not the same/different MMSI. The categories are represented by the positive and negative examples of the SAR-Ship comparison dataset discussed above. To tackle this binary image classification problem, the SAR-SAR image matcher 118 uses a deep learning approach based on a modified version of a classical Siamese neural network model (such as illustrated in FIG. 2) with transfer learning.

The modeling procedure may be divided into the following major steps: (1) data preprocessing for input to a CNN model; (2) Siamese architecture with transfer learning model; and (3) training results and model evaluation. In the next sections, we provide details for each of these steps.

### Data Preprocessing

To feed the data into a CNN model, a preprocessing step is applied to prepare SAR images to be fed into the machine learning model. This may generate an exploitation ready product by aligning and calibrating the data and makes the data ready for analytics. In some embodiments, the SAR image pixels may be normalized.

As described above, in an example, a SAR-ship comparison dataset was developed that includes 9315 ship chips labeled out of 15777, where 960 out of 9315 have same MMSI number (unique vessel identifier). From 960 ships with same MMSI, 1355 same MMSI pairs are created as a positive class and 1355 pairs are selected randomly out of 43,379,955 pairs with different MMSI (all the possible combinations of different MMSIs from 8355 image chips) to form a negative class. To create a training-evaluation dataset, the dataset is split randomly with 80% of the dataset as training and 20% for evaluation. So, the size of the training set is 2170 SAR ship chips containing 1084 ship chips for the negative class and 1084 ship chips for the positive class. The size of the evaluation dataset is 542, with each class containing 271 SAR ship chips. It should be noted that negative and positive classes do not have any overlap based on the MMSI number.

For this particular example, [300, 300, 3] was used as the input size for the CNN model, which corresponds to a fixed SAR-Ship chip size in the dataset. Note that the dataset SAR-Ships chips were not resized to the input size. The remaining space is padded with zeros in the case the SAR-Ship is smaller than fixed size chip. Further, it was attempted to keep the ships in the center of the chip (image). Nevertheless, the proposed technique is translation invariant. It should be further mentioned that the SAR images are one channel but the model is three channel, so as a first experiment, the SAR image is repeated for the three channels. In variations, other techniques may be used.

Siamese Model with Transfer Learning

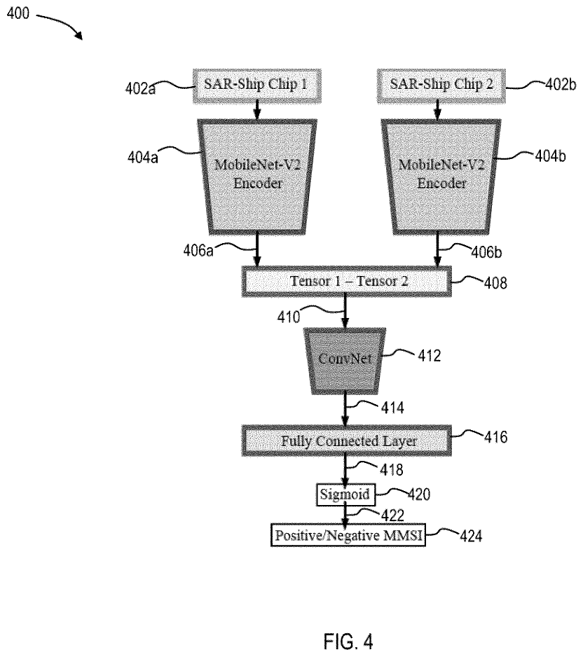

As the CNN model architecture (of image matcher model 122), a modified functional version of a classical Siamese neural network may be used. In an embodiment, a modified model architecture as shown in FIG. 4 is used. The input to the modified model includes two (first and second) SAR satellite ship images. The output of the model is an integer that is either 0 or 1. That is, the model is expected to output 1 when the first and second SAR images contain different ships or to output 0 when the first and second SAR images contain similar/the same ship with the same MMSIs.

As shown in FIG. 4, a modified Siamese architecture 400 has first and second main encoder branches 404a, 404b connected at the deeper network layers. Since the dataset contains only SAR satellite images, the same encoder is used in both branches 404a, 404b to reduce the number of learnable parameters. In an embodiment, only the top forty-five layers of a MobileNet V2 architecture are used as the encoder. A reason behind this modeling choice is that MobileNet V2 has shown a significant feature extraction performance on object detection and segmentation applications and better performance on small size datasets. The MobileNet V2's layers are used right before pooling is performed because this enables leveraging of the feature extraction functionality of the MobileNet architecture, while reducing the number of learnable parameters in the model.

The output of each encoder branch is a tensor representing encoded features of the respective input SAR-Ship image. That is, encoder 404a outputs a first tensor 406a (tensor 1) representing encoded features of first SAR image 402a, and encoder 404b outputs a second tensor 406b (tensor 2) representing encoded features of second SAR image 402b. The two output tensors 406a, 406b are subtracted 408 to obtain a tensor difference 410. The tensor difference 410 is output and fed into a ConvNet (i.e., CNN). This allows for performance of a second cycle of feature extraction. In an embodiment, the ConvNet 412 has two layers of convolutional (3×3 kernel, 256 filter size), ReLU activation, and max pooling, respectively. An additional convolutional layer (3×3 kernel, 256 filter size) is then placed at the bottom of the ConvNet 412. An output 414 of the ConvNet 412 is then fed into a fully connected layer 416, which connects into a sigmoid function 420. An output of the fully connected layer 416 is output to the sigmoid function 420. Finally, the sigmoid function 420 returns a value 422 in the interval [0, 1]. The value is rounded to the nearest integer (ie., 0 or 1) at inference time. The value 422 may be translated into or represent a positive or negative unique vessel identifier (MMSI) 424.

Next, to formulate the learning problem, a regularized cross-entropy loss function may be used. The learning problem refers to the optimization problem to be solved to compute optimal CNN and classifier weights to perform the desired binary image classification task. To regularize the loss function, L2 regularization may be used. As described below, the results obtained using a regularized loss function can lead to more accurate inference models.

To boost the accuracy of the model 122 in early training steps, transfer learning may be used as a type of weight initialization scheme for the optimization procedure. That is, the weights of a CNN model previously trained on a related problem may be used as a starting point in the training procedure. In an embodiment, pre-trained ImageNet weights are used. These weights have been optimized to state-of-the-art performance for detecting and extracting generic features from photographs. These weights are trained in more than 1,000,000 images for 1,000 categories.

To evaluate the model, standard metrics to measure performance of a binary classification problem may be used including accuracy, precision, recall, and F1 score.

### Results and Model Evaluation

The following discusses demonstrated performance of the previously described Siamese network model for SAR-Ship re-identification tasks on the previously described SAR-Ship comparison dataset.

In a first experiment, the SAR-Ship dataset was split to training-evaluation dataset with 80% for training and 20% for evaluation. As mentioned, the SAR-Ship comparison dataset has positive and negative examples equally distributed with the same number of ship images in each class (referred to as a balanced case).

The previously described Siamese model is trained with and without L2 regularization for the dataset splits described before. To solve the optimization (learning) problem described previously, an Adam optimizer is used with an exponential decay rate for the first and second moment of 0.9 and 0.999, respectively. After performing hyper-parameter tuning for different learning rates, batch sizes, and regularization parameters, it is found that using a fixed learning rate of 1e-5 over 200 to 300 epochs, an L2 regularization parameter of 1e-3, and a batch size of 32 examples at each training step leads to the best parameter configuration on GPU cluster using TensorFlow 2.

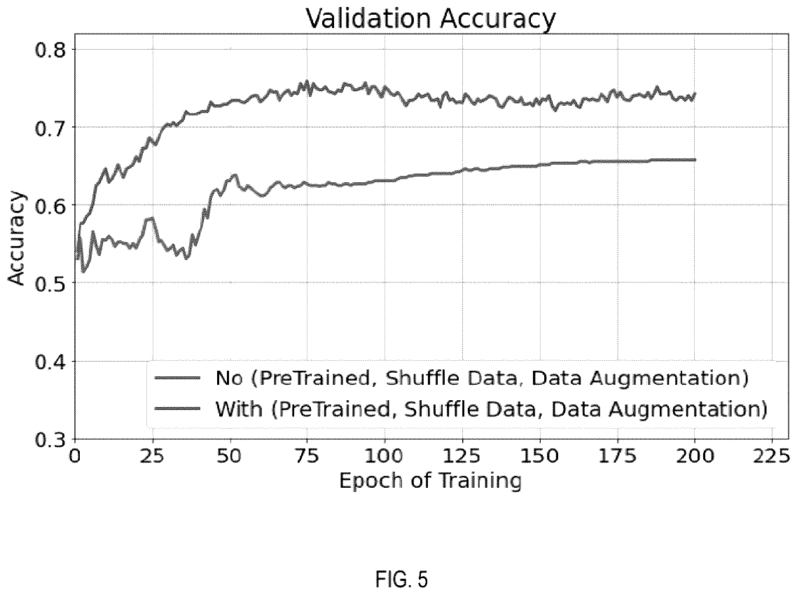

Two different scenarios were tested during training, including using data augmentation and shuffle a fraction of the dataset at each epoch followed by transfer learning as previously described. The second experiment focuses on not applying data augmentation, shuffling the data in each epoch with training from scratch. Both models were trained for 200 epochs. Referring now to FIG. 5, it is observed that the model using data augmentation, shuffling data and using transfer learning produces a better training model. FIG. 5 illustrates the No-PSA (Pre-trained, Shuffle and Augmentation data) curve starts from 51% accuracy and increases to 65.7% that shows no significant improvement after epoch 75. This is in contrast to With-PSA curve, which reaches 0.75.8% accuracy in 75 epochs. This is a result of the effect of random shuffle in each epoch, applying an ImageNet pre-trained model, and using random rotation as data augmentation.

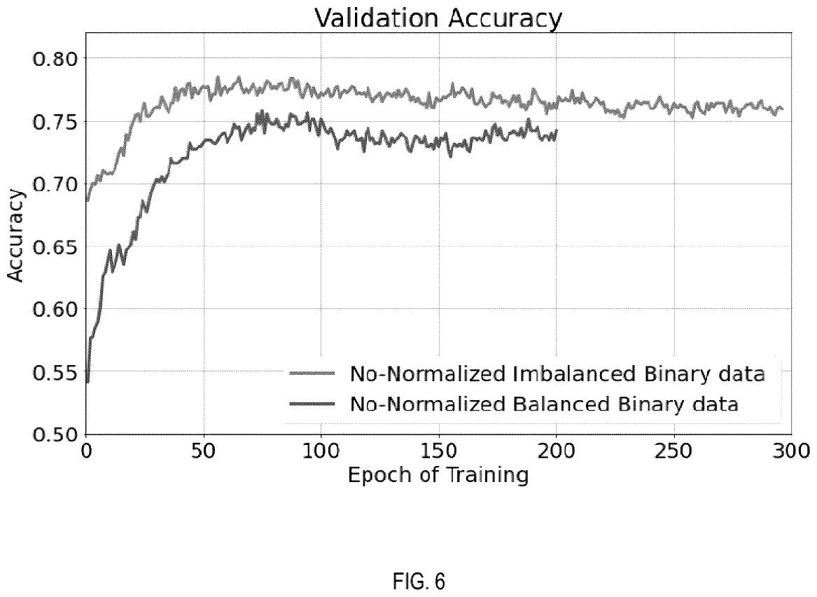

In the next experiment, the size of the negative class that is different MMSI pairs is increased. So, 1084 different MMSI pairs were added for the training and 271 for evaluation randomly from the SAR-Ship dataset described previously. Accordingly, the training set contains 3,252 SAR-Ship pairs. The negative class has 2168 different MMSI pairs and the positive class has 1084 same MMSI pairs. The evaluation set has 813 pairs, the same as the training set. This experiment is called an imbalanced scenario. Referring now to FIG. 6, shown therein is a comparison between balanced and imbalanced setting for a not normalized SAR-Ship dataset, as described above. The results in FIG. 6 show that by increasing the size of negative class, the accuracy improved to 78.5% after 56 epoch and there is an overall boosting in the imbalanced data curve.

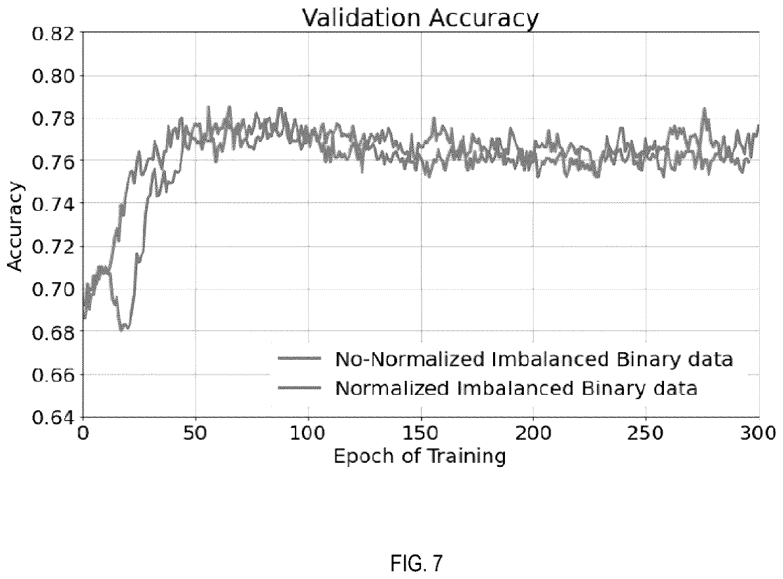

For the next experiment, imbalanced data is selected and then each SAR image is normalized with respect to its maximum value so the values in each image are normalized between [0 1]. Referring now to FIG. 7, shown therein is a comparison between normalized and not-normalized versions of an imbalanced SAR-Ship dataset. FIG. 7 shows both models reached the same accuracy in different epochs.

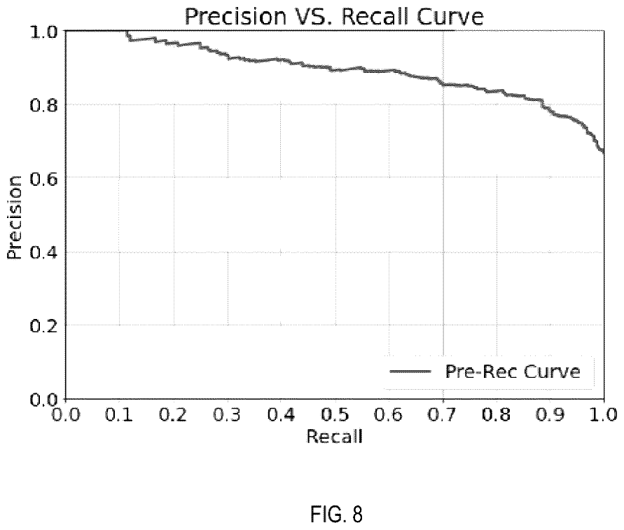

Referring now to FIG. 8, shown therein is a precision versus recall curve of an imbalanced dataset without normalization (78.5% accuracy is obtained in epoch 56). FIG. 8 shows the Receiver Operating Characteristic (ROC) curve of the inference model on the evaluation dataset. A ROC curve diagnoses the ability of a binary classifier as the discrimination threshold is varied. The Area Under the Curve (AUC) is 0.8458.

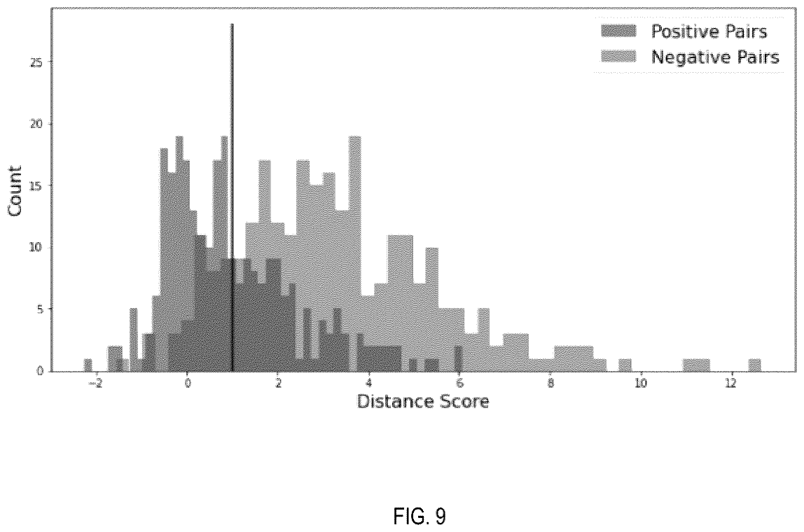

Referring now to FIG. 9, shown therein is a graph plotting the matching scores calculated from the feature vectors output by the model. In FIG. 9 it can be seen that the negative and positive pairs result in two score distributions with clearly distinct peaks, but overlapping tails. To calculate the detection and false alarm rates, a threshold was set to many possible values between zero and one. For each threshold value, it is set such that scores below are predicted not to match and scores above threshold are predicted to match. An example threshold is shown by a vertical black line in FIG. 9, which shows that false predictions come from the overlapping tails of the two distributions. In addition to the PD and PFa rates, the precision and recall can be calculated for each threshold as well as the F1 score, which is an average of the two. The following table shows the result of PD and PFa for the positive and negative classes:

TABLE 6-3
Result of PD and PFa for the positive and negative classes.

| P(Y\|Z) | Z = T | Z = F |
|---|---|---|
| Y = P | 0.70 | 0.20 |
| Y = N | 0.30 | 0.80 |

The impact of the ship size on the performance of the previously described Siamese model was also explored and will now be discussed. In these experiments, ship size is defined as the AIS reported length.

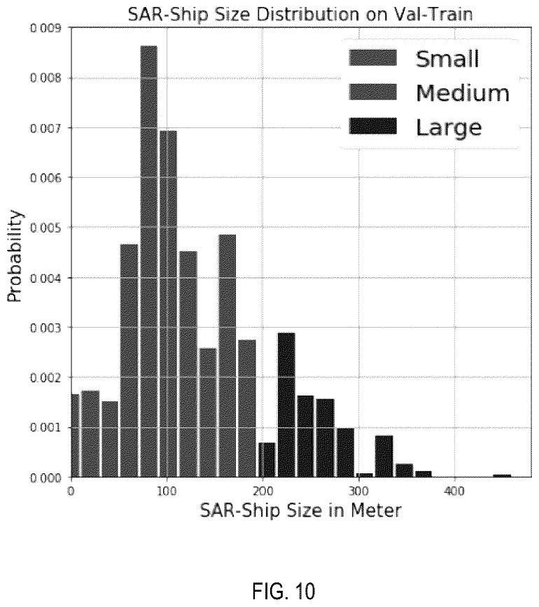

Referring now to FIG. 10, shown therein are histograms of the ship pixel size for the train-evaluation dataset with same MMSI. The ship lengths are sub-divided into three categories: small, medium, and large. Small ships are defined to have an AIS length between 0px to 60px. Medium-sized ships are defined to have an AIS length between 60px to 200px. Large ships are defined to have an AIS length between 200px to 450px.

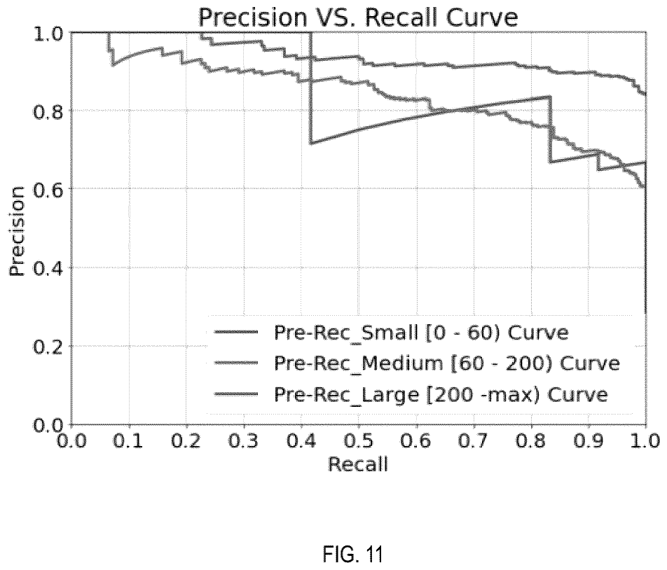

Referring now to FIG. 11, shown therein is a plot of the precision vs. recall curve for each ship size category on the evaluation dataset. As one might expect, the Large and Medium-sized ships performed the best. The re-identification of small ships performed the worst. Since a majority of the ships are large and medium-sized, it is not surprising that the model formed a bias in these categories. As for small ships, if these ships appear with small resolution, then the recognition task gets more difficult for the model.

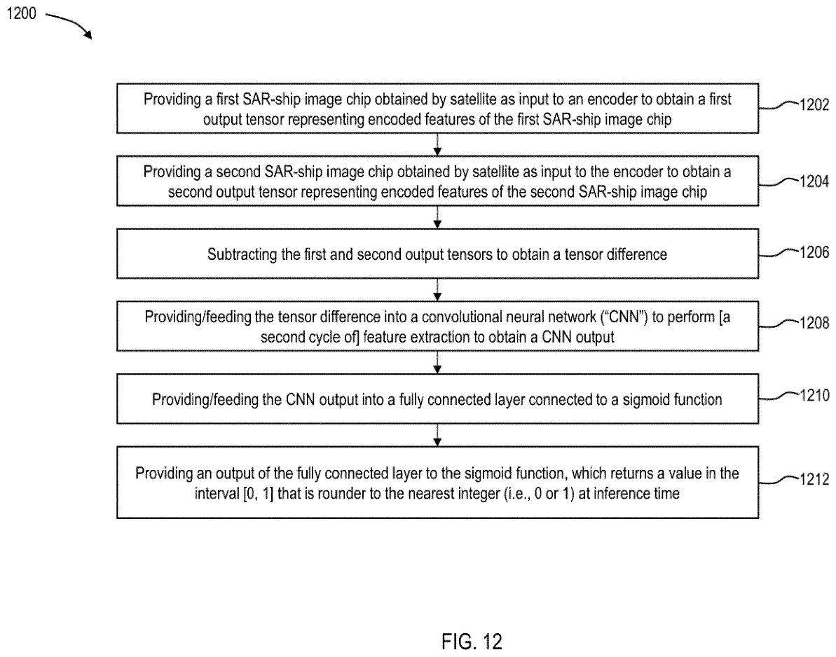

Referring now to FIG. 12, shown therein is a method of object identification using SAR-SAR image matching, according to an embodiment.

The method 1200 may be encoded as computer-executable instructions and executed by one or more computing devices comprising one or more processors. In an embodiment, the method 1200 may be executed by the computer system 100 of FIG. 1.

At 1202, the method 1200 includes providing a first SAR-ship image chip obtained by satellite as input to an encoder to obtain a first output tensor representing encoded features of the first SAR-ship image chip.

The first SAR image may be of an unknown vessel or object, such as new SAR image 116 of FIG. 1, and for which a user wishes to know the identity of the vessel.

At 1204, the method 1200 includes providing a second SAR-ship image chip obtained by satellite as input to the encoder to obtain a second output tensor representing encoded features of the second SAR-ship image chip.

The second SAR image may be a known vessel or object, such as known SAR image 112 of FIG. 1, for which the identity of the vessel contained in the image is known (and represented by a unique identifier, such as an MMSI).

At 1206, the method 1200 includes subtracting the first and second output tensors to obtain a tensor difference.

At 1208, the method 1200 includes providing the tensor difference into a convolutional neural network (“CNN”) to perform a second cycle of feature extraction to obtain a CNN output. The CNN output comprises a new feature vector representing the differences in the two tensor inputs.

At 1210, the method 1200 includes providing the CNN output to a fully connected layer connected to a sigmoid function, and processing via the fully connected layer.

At 1212, the method 1200 includes providing an output of the fully connected layer to the sigmoid function. The output of the fully connected layer is two numbers representing scores indicating how well the images either match or do not match, that are not bound between 0 and 1.

The sigmoid function returns a value in the interval [0, 1]. The value may be rounded to the nearest integer (i.e., 0 or 1) at inference time. The value may be used to make a positive/negative MMSI determination (i.e., whether the MMSI associated with the second SAR image should be assigned to the first SAR image (indicating that the image matcher has determined that the vessels appearing in the first and second SAR images are the same.

The sigmoid function returns two numbers between 0 and 1 that sum to 1. One number can be ignored, and then a threshold is chosen to be between 0 and 1. In some embodiments, the threshold is 0.5. If the sigmoid output is greater than 0.5, it is a match, and if the sigmoid output is less than 0.5 it is a non-match prediction.

In some embodiments, a candidate list (e.g., a list of SAR images containing known vessels that are deemed candidates for matching) is provided from a feasible ship finder module or component (which, in some embodiments, may be a component of system 100, or accessible to system 100 such as through a system interface or network connection). In the case of binarized predictions, all candidates that are deemed matches may be presented in a graphical user interface displayed on at operator device. The operator may then review the matches in the user interface. The system 100 may include the graphical user interface and operator device, or the graphical user interface and operator device may be otherwise communicatively connected or accessible to the system, such as via a system interface or network connection.

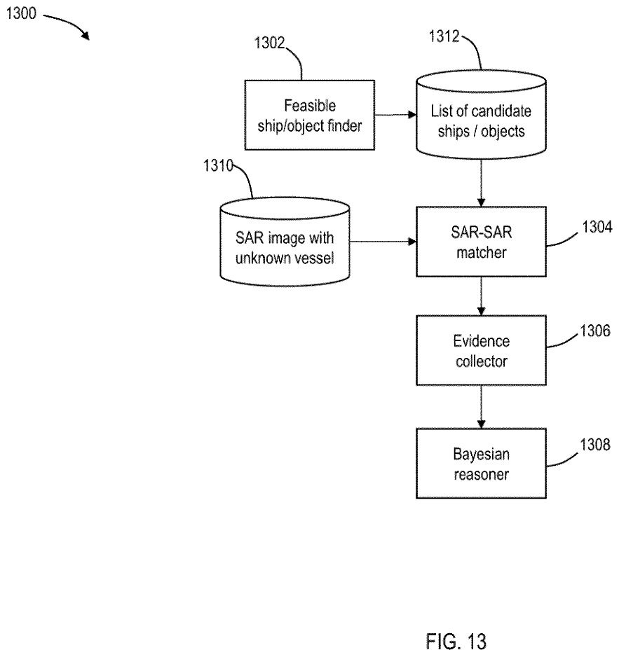

Referring now to FIG. 13, shown therein is a system 1300 for vessel reidentification using multiple image source types including satellite imagery, according to an embodiment.

The system 1300 includes a feasible ships finder module 1302, a SAR-SAR image matcher 1304, and evidence collector module 1306, and a Bayesian reasoner module 1308. The SAR-SAR image matcher 1304 may include one or more components of system 100. The SAR-SAR image matcher 1304 receives an unknown SAR image 1310 of an unknown ship and a list of SAR images of candidate ships 1312. The unknown SAR image 1310 and the list of SAR images of candidate ships 1312 were acquired and generated by a SAR satellite imaging system. The list of candidate ships 1312 is determined by the feasible ship finder module 1302. The SAR-SAR image matcher 1304 receives an observed SAR ship image 1310 and a set of known candidate images 1312 (or their feature vectors). In some cases, only the feature vectors of the candidate images may be provided to and used by the SAR-SAR image matcher in the comparison (i.e., to a feature vector of the unknown SAR image generated by the matcher 1304). The known candidate images 1312 come from a database of known SAR images and are selected by the feasible ship finder 1302. The SAR-SAR image matcher 1304 outputs a binary answer (e.g., yes/no) for each image in the list of candidate images 1312 indicating whether the model thinks that the ship in the respective candidate image matches the ship in the unknown SAR image 1310, which has a certain probability of being correct, that is collected by the evidence collector module 1306 and used by the downstream Bayesian reasoner 1308. The output of the SAR-SAR image matcher 1304 may include a match score for each image in the candidate list 1312. The output of the SAR-SAR image matcher 1304 is sent to the evidence collector 1306 and eventually the Bayesian reasoner 1308. For example, the output of the SAR-SAR image matcher 1304 may be an instance of the list of candidate ships 1312 (or some subset thereof) ordered according to match score. Downstream the match score may be converted into a probability of matching which can be used by the Bayesian reasoner 1308. The Bayesian reasoner 1308 may combine the matching probability with other evidence collected by the evidence collector 1306, such as how well the observed ship's estimated length and width match with those in the candidate list 1312. In some embodiments, match score outputs generated by the SAR-SAR image matcher 1304 are converted into calibrated probabilities that can be combined with other probabilities or probability inputs by the Bayesian reasoner module 1308.

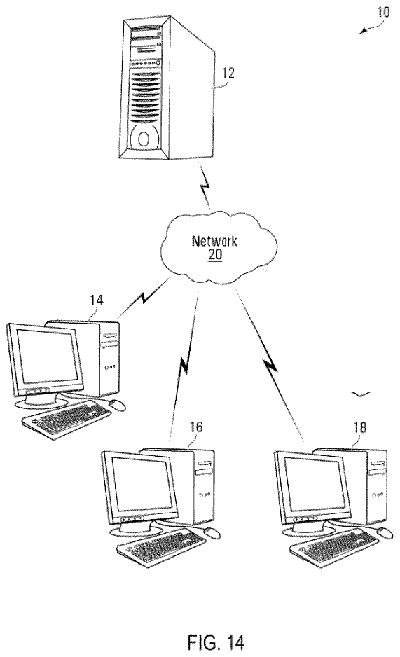

Referring now to FIG. 14, shown therein is a computer system for object identification using SAR-SAR image matching, according to an embodiment.

The system 10 includes a server platform 12 which communicates with a plurality of database server devices 14, a plurality of model training devices 16, and a plurality of user devices 18 via a network 20. The server platform 12 may be a purpose-built machine designed specifically for performing object identification (e.g., marine vessel identification) using SAR-SAR image matching.

The server platform 12, database server devices 14, model training devices 16, and user devices 18 may be a server computer, desktop computer, notebook computer, tablet, PDA, smartphone, or another computing device. The devices 12, 14, 16, 18 may include a connection with the network 20 such as a wired or wireless connection to the Internet. In some cases, the network 20 may include other types of computer or telecommunication networks. The devices 12, 14, 16, 18 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage or may be received from the Internet or other network 20. Input device may include any device for entering information into device 12, 14, 16, 18. For example, input device may be a keyboard, keypad, cursor-control device, touchscreen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18 may include multiple of any one or more of processors, applications, software modules, second storage devices, network connections, input devices, output devices, and display devices.

Although devices 12, 14, 16, 18 are described with various components, one skilled in the art will appreciate that the devices 12, 14, 16, 18 may in some cases contain fewer, additional or different components. In addition, although aspects of an implementation of the devices 12, 14, 16, 18 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18 and/or processor to perform a particular method.

In the description that follows, devices such as server platform 12, database server devices 14, model training devices 16, and user devices 18 are described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

As an example, it is described below that the devices 12, 14, 16, 18 may send information to the server platform 12. For example, a user using the user device 18 may manipulate one or more input devices (e.g. a mouse and a keyboard) to interact with a user interface displayed on a display of the user device 18. Generally, the device may receive a user interface from the network 20 (e.g. in the form of a webpage). Alternatively, or in addition, a user interface may be stored locally at a device (e.g. a cache of a webpage or a mobile application).

Server platform 12 may be configured to receive a plurality of information, from each of the plurality of database server devices 14, model training devices 16, and user devices 18. Generally, the information may comprise at least an identifier identifying the database server, model training device, or user. For example, the information may comprise one or more of a username, e-mail address, password, or social media handle.

In response to receiving information, the server platform 12 may store the information in storage database. The storage may correspond with secondary storage of the device 12, 14, 16, 18. Generally, the storage database may be any suitable storage device such as a hard disk drive, a solid state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

The database server device 14 may be associated with a database server account. Similarly, the model training device 16 may be associated with a model training account, and the user device 18 may be associated with a user account. Any suitable mechanism for associating a device with an account is expressly contemplated. In some cases, a device may be associated with an account by sending credentials (e.g. a cookie, login, or password etc.) to the server platform 12. The server platform 12 may verify the credentials (e.g. determine that the received password matches a password associated with the account). If a device is associated with an account, the server platform 12 may consider further acts by that device to be associated with that account.

While the above description provides examples of one or more apparatus, methods, or systems, it will be appreciated that other apparatus, methods, or systems may be within the scope of the claims as interpreted by one of skill in the art.

1. A computer system for computer vision-based maritime surveillance and identification of unknown vessels, the system comprising:
at least one data storage device storing:
a database of known synthetic aperture radar (“SAR”) satellite images each containing a known candidate vessel, each known candidate vessel having a known unique vessel identifier associated therewith that is stored in the database and which identifies the known candidate vessel; and
an unknown SAR satellite image containing an unknown vessel; and
at least one processor configured to execute a SAR-SAR image matcher, the SAR-SAR image matcher configured to:
compare, via a neural network, the unknown SAR image to a plurality of known SAR image in the database, the comparing including determining a match likelihood score indicating a likelihood that the unknown vessel in the unknown SAR image and a known vessel in a respective known SAR image are a match;
output, via the neural network, a ranked list of the known SAR images, the ranked list based on the determined match likelihood scores, wherein a higher ranking in the ranked list indicates a higher match likelihood score and greater likelihood of the known vessel in the known SAR image being the same as the unknown vessel in the unknown SAR image; and
assign a known unique vessel identifier to the unknown SAR image based on the ranked list.

2. The system of claim 1, wherein the SAR-SAR image matcher is further configured to store the unknown SAR image as a new known SAR image in the database, the database including the assigned known vessel identifier in association with the new unknown SAR image.

3. The system of claim 1, wherein the at least one processor is further configured to execute a user interface module configured to display a graphical user interface including a graphical representation of the ranked list and receive a user input selecting a known SAR image from the ranked list, and wherein the assigning includes assigning, in response to the user input, the known vessel identifier associated with the selected known SAR image to the unknown SAR image.

4. The system of claim 1, wherein the graphical representation of the ranked list includes, for each known SAR image in the ranked list, a visual representation of the known SAR image.

5. The system of claim 1, wherein assigning the known unique vessel identifier to the unknown nadir image is performed automatically without user input by the SAR-SAR image matcher based on a match likelihood score of a known SAR image associated with the known unique vessel identifier exceeding a predetermined threshold match likelihood score.

6. The system of claim 1, wherein the at least one processor is further configured to execute a user interface module configured to: display a graphical user interface including the assignment of the known vessel identifier to the unknown SAR image and a visual representation the known SAR image associated with the known unique vessel identifier and the unknown SAR image; and receive a user input confirming or rejecting the assignment.

7. The system of claim 1, wherein the unique vessel identifier is a maritime mobile service identify number.

8. The system of claim 1, wherein the neural network is a Siamese neural network configured to receive a plurality of SAR image pairs as input, each SAR image pair including the unknown SAR image and a known SAR image from the database.

9. The system of claim 1, wherein a trajectory comprising a time and location of the unknown vessel is encoded with the unknown SAR image and used by the at least one processor to determine the plurality of known SAR images to which the unknown SAR image is compared by the SAR-SAR image matcher.

10. The system of claim 1, wherein the plurality of known SAR images represents a list of candidate vessels identified by a feasible vessel finder module based on a trajectory of unknown vessel in the unknown SAR image.

11. The system of claim 10, wherein the at least one processor is further configured to execute the feasible vessel finder module to obtain the list of candidate vessels.

12. The system of claim 1, wherein the unknown SAR image has only one time and location encoded therewith that is used to determine the plurality of known SAR images for comparison with the unknown SAR image via a trajectory analysis.

13. A method of computer vision-based maritime surveillance and identification of unknown vessels, the method comprising:
comparing, via a neural network, a cropped unknown synthetic aperture radar (“SAR”) image chip to at least one known SAR image chip of a known vessel stored in a SAR imagery database, the comparing including determining a match likelihood score indicating a match likelihood level between the cropped unknown SAR image chip and the compared known SAR image chip, the known SAR image chip containing a known candidate vessel having a known unique vessel identifier associated therewith that is stored in association with the known SAR image chip and which identifies the known candidate vessel;
outputting, via the neural network, a ranked list of the known SAR image chips that were compared to the cropped unknown SAR image chip, the ranked list based on the determined match likelihood scores, wherein a higher ranking in the ranked list indicates a higher match likelihood score and greater likelihood of the known vessel in the known SAR image chip being the same as the unknown vessel in the unknown SAR image chip; and
assigning at least one unique vessel identifier to the cropped unknown SAR image chip based on the ranked list.

14. The method of claim 13, further comprising identifying a trajectory of the unknown vessel in the unknown SAR image chip and using the trajectory to identify a subset of the known SAR image chips in the SAR imagery database for comparison to the unknown SAR image.
